(19) United States
(12) Patent Application Publication
(10) Pub. No.: US 2009/0158904 A1
(43) Pub. Date: Jun. 25, 2009

(54) DUST COLLECTOR FOR A MITER SAW

(75) Inventor: Jung-Huo Chen, Taichung (TW)

Correspondence Address: BACON & THOMAS, PLLC, 625 SLATERS LANE, FOURTH FLOOR, ALEXANDRIA, VA, 22314-1176, US

(73) Assignee: Rexon Industrial Corp., Ltd., Taichung (TW)

(21) Appl. No.: 12/333,428

(22) Filed: Dec. 12, 2008

(30) Foreign Application Priority Data
Dec. 24, 2007 (TW) 096149796

(51) Int. Cl. B26D 7/18; B26D 1/157

(52) U.S. Cl. 83/162; 83/471.3

(57) ABSTRACT

A dust collector for a miter saw includes a link and a dust collection member. The link has a first end connected to a saw blade guard of the miter saw and a second end opposite to the first end. The saw blade guard defines an inside space thereof in communication with a dust flue. The dust collection member is pivotally connected to the saw blade guard of the miter saw and is slidably coupled to the second end of the link. The dust collection member has a channel within which the saw blade passes during a cutting operation to cut a workpiece so that the channel guides cut chips from the workpiece to the outside of the miter saw via the inside space of the saw blade guard and the dust flue.

### BACKGROUND

1. Field of the Invention

The present invention relates to a miter saw and more particularly, to a dust collector for a miter saw.

2. Description of Related Art

When operating a miter saw to cut a workpiece, cut chips are produced, therefore a dust collector, for example, a dust collection duct is usually used to collect cut chips.

However, a dust collection duct is normally installed in the saw arm of the miter saw. When rotating the saw blade to cut the workpiece, the distance between the entrance of the dust collection duct and the location where cut chips are driven away from the workpiece by the saw blade may be changed subject to the biasing angle of the saw arm or the height of the workpiece. When the entrance of the dust collection duct is kept in proximity to the location where cut chips are driven away from the workpiece by the saw blade, cut chips can enter the duct collection conduct easily. On the other hand, when the entrance of the dust collection duct is maintained in a position far from the location where cut chips are driven away from the workpiece by the saw blade, cut chips may fall away from the miter saw to contaminate the surroundings.

Exemplary dust collectors are disclosed in U.S. Pat. No. 6,742,425 and U.S. publication No. 2006/0230898. These two disclosures commonly use a resilient dust flap oriented towards the workpiece to guide cut chips to enter the entrance of the dust collection duct. However, the dust flap may not be maintained in proximity to the workpiece due to a difference of workpiece height, thus lowering the dust collection performance.

### SUMMARY

The present disclosure has been accomplished under the circumstances in view. Accordingly, an embodiment of a miter saw having a dust collector is provided, which enables the miter saw to provide excellent cut chip collection performance.

An exemplary miter saw comprises a saw arm and a saw blade. The saw arm comprises a saw blade guard and a dust flue. The saw blade guard partially surrounds the saw blade. The saw blade guard defines an inside space that is in communication with the dust flue. The dust collector comprises a link and a dust collection member. The link has a first end connected to the saw blade guard of the saw arm and a second end opposite to the first end. The dust collection member is pivotally connected to the saw blade guard and is slidably coupled to the second end of the link. The dust collection member comprises a channel within which the saw blade passes during a cutting operation to cut a workpiece so that the channel guides cut chips from the workpiece to the outside of the miter saw via the inside space of the saw blade guard and the dust flue.

### BRIEF DESCRIPTION OF THE DRAWINGS

FIG. 1 is an elevational view of a miter saw equipped with a dust collector in accordance with the present embodiment.

FIG. 2 is an enlarged view of a part of FIG. 1.

FIG. 3 is an elevational view of the dust collector in accordance with the present embodiment.

FIG. 4 is a side view of FIG. 2.

FIG. 5 is a schematic side view, showing a dust collection status of the dust collector during operation of the miter saw.

### DETAILED DESCRIPTION OF EMBODIMENTS

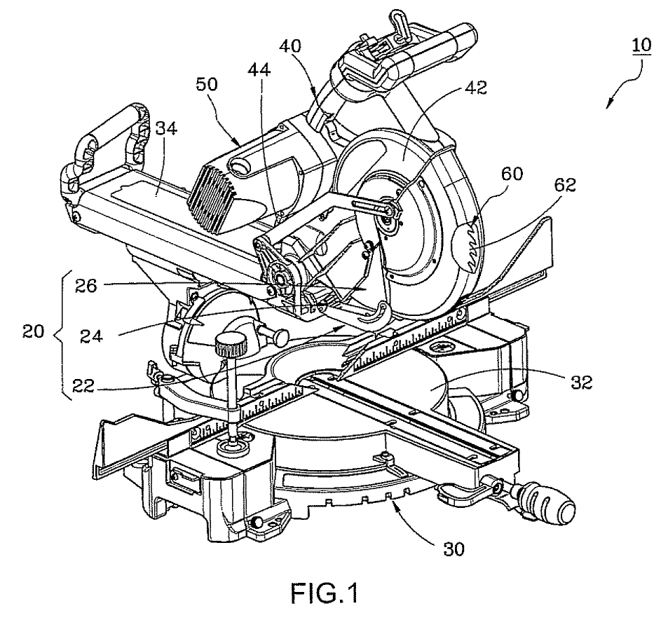

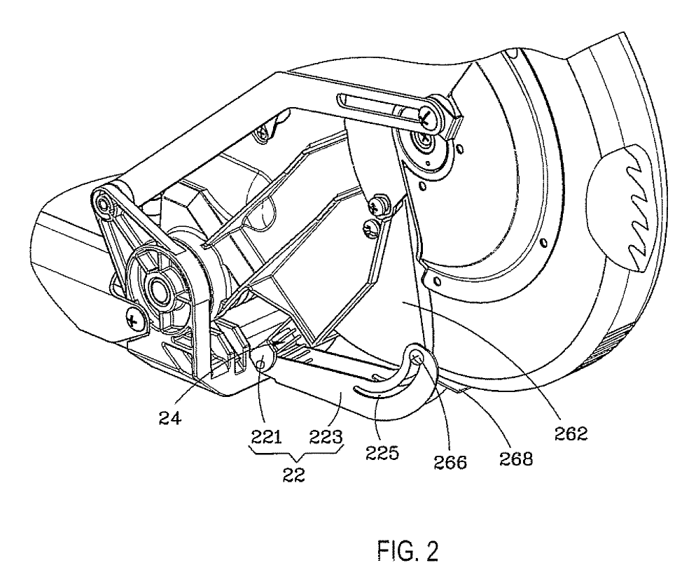

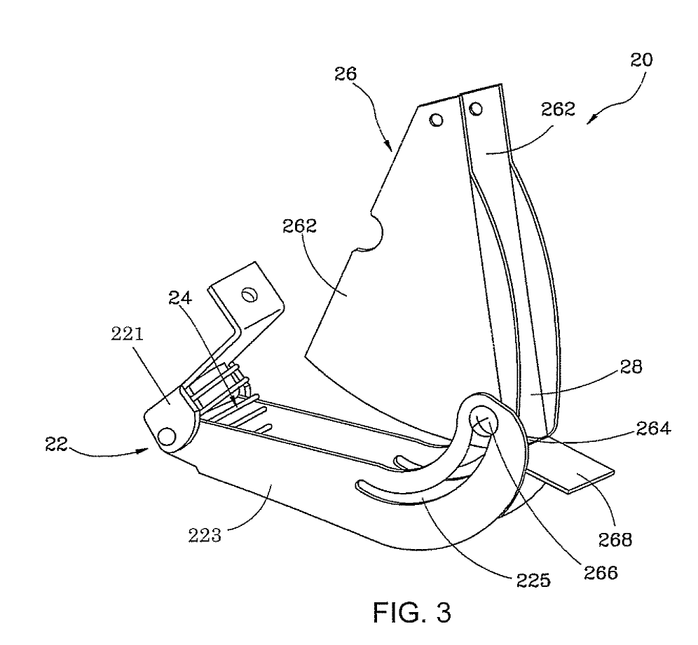

Referring to FIGS. 1 and 2, a dust collector 20 in accordance with the present disclosure is shown installed in a miter saw. The miter saw comprises a machine base 30, a saw arm 40, a driving device 50, and a saw blade 60. The machine base 30 has a worktable 32 for holding a workpiece for cutting, and a sliding track assembly 34 slidable forwards and backwards relative to the worktable 32. The saw arm 40 is pivotally mounted on the sliding track assembly 34, and is movable upwards and downwards relative to the worktable 32. The saw arm 40 is equipped with a saw blade guard 42 and a dust flue 44 in communication with an inside space of the saw blade guard 42 defined between the sidewalls and the protective end wall of the saw blade guard 42. The driving device 50 according to the present embodiment is a motor installed on the saw arm 40. The saw blade 60 is partially surrounded by the saw blade guard 42 and is coupled to and rotatable by the driving device 50 to cut the workpiece. When sliding the sliding track assembly 34, the saw arm 40 is moved horizontally, and therefore the saw blade 60 is moved horizontally. As shown in FIG. 3, the dust collector 20 is comprised of a link 22, a spring member 24, and a dust collection member 26.

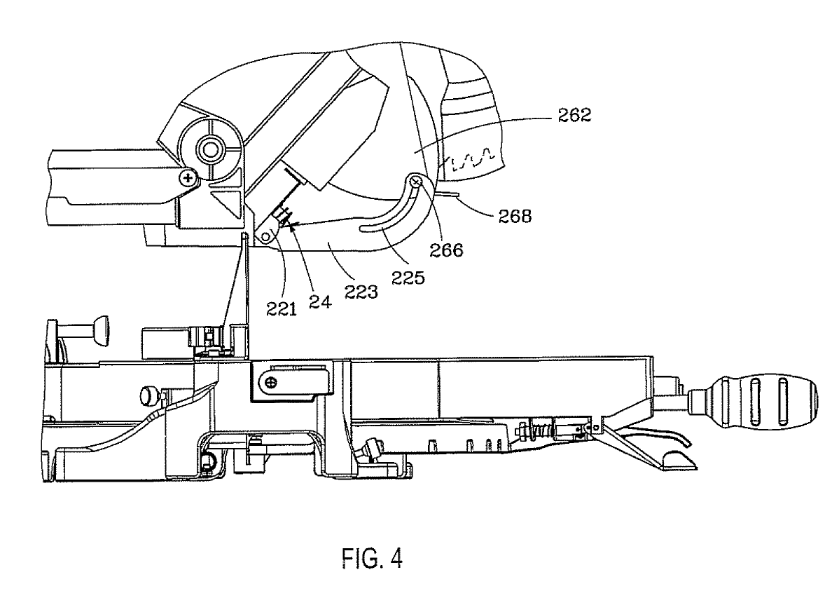

Referring again to FIGS. 2-4, the link 22 is comprised of a first connection member 221 and a second connection member 223. The first connection member 221 has its top end fixedly connected to the saw blade guard 42, and its bottom end pivotally connected to the rear end of the second connection member 223. The second connection member 223 has two arched sliding slots 225 bilaterally disposed at its front end.

The biasing member 24, which may be a compression spring, is provided between the first connection member 221 and the second connection member 223 adjacent to the pivot joint between the first connection member 221 and the second connection member 223. The biasing member 24 has one end contacting the first connection member 221 and its other end contacting the second connection member 223. The biasing member 24 is adapted to impart a return force to the first connection member 221 and the second connection member 223 when the first connection member 221 and the second connection member 223 are moved toward each other to compress the biasing member 24.

The dust collection member 26 has two generally triangular-shaped sidewalls 262 and an end wall 264. The end wall 264 is connected between the two sidewalls 262 at the bottom side thereof. The dust collection member 26 has a substantially U-shaped cross section, defining a channel 28 in communication with the inside space of the saw blade guard 42. The tops of the sidewalls 262 of the dust collection member 26 are respectively pivotally connected to the saw blade guard 42 at two sides relative to the saw blade 60. The saw blade 60 has its teeth 62 partially suspended in the channel 28. The tangent direction of the saw blade 60 is the same as the extending direction of the channel 28. Further, the dust collection member 26 has two protruding portions 266 respectively extending from the sidewalls 262 and respectively coupled to the arched sliding slots 225 of the second connection member 223, enabling the dust collection member 26 to be moved downwards with the saw blade guard 42. When the second connection member 223 is stopped from further downward movement by engagement with the workpiece 70, the protruding portions 266 are moved along the arched sliding slots 225 relative to the second connection member 223. Further, the dust collection member 26 has a baffle 268 extended from the end wall 264 corresponding to the entrance of the channel 28.

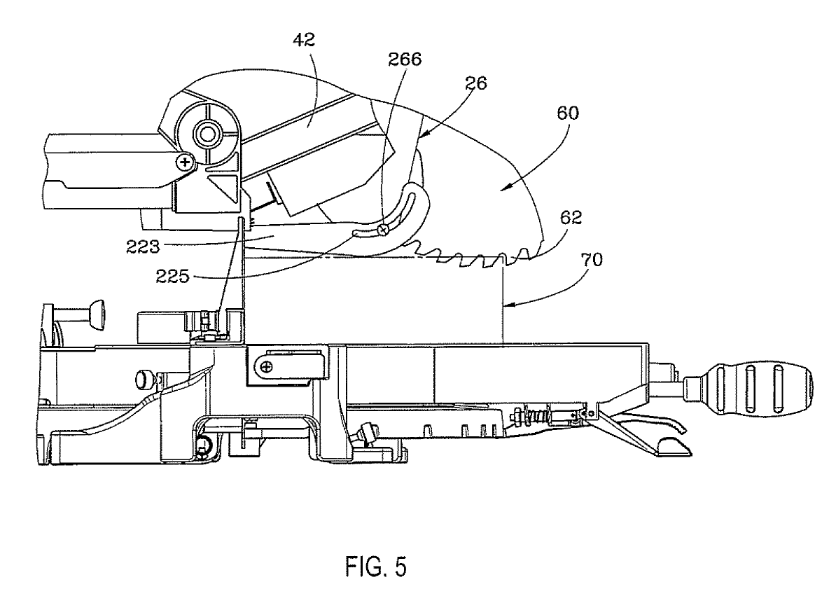

When moving the saw blade 60 and saw blade guard 42 of the miter saw 10 downwards to cut the workpiece 70, as shown in FIG. 5, the second connection member 223 of the link 22 is forced to stop against the workpiece 70. At this time, the spring member 24 is compressed, and the protruding portions 266 of the dust collection member 26 are moved downwards along the arched sliding slots 225 from the top ends of the arched sliding slots 225 toward the bottom ends thereof, causing the dust collection member 26 to be turned relative to the saw blade guard 42, thus the channel 28 of the dust collection member 26 is maintained in close proximity to the location where cut chips are driven away from the workpiece 70. Because the two sidewalls 262 of the dust collection member 26 are disposed at two sides relative to the saw blade 60 between the location where cut chips are driven away from the workpiece 70 by the teeth 62 of the saw blade 60 and the dust flue 44, the cut chips that are driven away from the workpiece 70 are delivered to the channel 28 of the dust collection member 26 by the centrifugal force and rotating airflow being produced during rotation of the saw blade 60 and then guided to the outside by the saw blade guard 42 and the dust flue 44. When the saw blade 60 is moved away from the workpiece 70, the biasing member 24 biases the first connection member 221 and the second connection member 223 to a return position, thereby pushing the protruding portions 266 of the dust collection member 26 to the top ends of the arched sliding slots 225. Therefore, the dust collection member 26 is returned to its former position. Further, the baffle 268 that is extended from the end wall 264 is suspended in the entrance of the channel 28 to guide cut chips into the channel 28 to enhance cut chip expelling efficiency.

Based on the aforesaid arrangement, the dust collection member is maintained in contact with the workpiece by way of the second connection member so that the dust collection member is automatically biased subject to the cutting elevation or horizontal movement of the saw arm, therefore keeping the channel of the dust collection member in close proximity to the location where cut chips are driven out of the workpiece by the saw blade to accurately guide and collect cut chips from the workpiece. Accordingly, a miter saw that uses the dust collector according to the present disclosure provides excellent dust collection performance.

Although a particular embodiment of the disclosure has been described in detail for purposes of illustration, various modifications and enhancements may be made without departing from the spirit and scope of the disclosure. Accordingly, the disclosure is not to be limited except as by the appended claims.

What is claimed is:

1. A dust collector to collect cut chips, the dust collector comprising:
a link having a first end configured to connect to a saw blade guard defining an inside space thereof in communication with a dust flue, and said link having a second end opposite to said first end; and
a dust collection member configured to be pivotally connected to a saw blade guard and slidably coupled to the second end of said link, said dust collection member having a channel configured to allow a saw blade to pass therethrough during a cutting operation to cut a workpiece such that said channel is configured to guide cut chips from a workpiece to the outside of a saw via a saw blade guard defining an inside space thereof in communication with a dust flue.

2. The dust collector according to claim 1, wherein the extending direction of said channel is configured to be substantially the same as a tangent direction of a saw blade arranged to pass therethrough.

3. The dust collector according to claim 1, wherein said link comprises a first connection member and a second connection member, said first connection member having one end thereof pivotally connected to one end of said second connection member and an opposite end thereof configured to be connected to a saw blade guard, said second connection member having an opposite end thereof slidably coupled to said dust collection member.

4. The dust collector according to claim 3, further comprising a biasing member positioned between said first connection member and said second connection member.

5. The dust collector according to claim 3, wherein said second connection member comprising two sliding slots, said dust collection member comprises two protruding portions respectively slidably coupled to said sliding slots of said second connection member.

6. The dust collector according to claim 5, wherein said sliding slots of said second connection member are smoothly arched.

7. The dust collector according to claim 5, wherein said dust collection member comprises two sidewalls configured to be respectively pivotally connected to a saw blade guard, and an end wall connected between said sidewalls at a bottom side thereof and defining with said side walls said channel; said protruding portions respectively extending from said sidewalls.

8. The dust collector according to claim 7, wherein said dust collection member further comprises a baffle suspended in an entrance of said channel.

9. A miter saw comprising:
a machine base having a worktable configured to hold a workpiece for cutting;
a saw arm pivotally mounted on said machine base and having a saw blade guard defining an inside space thereof in communication with a dust flue;
a driving device mounted on the saw arm;
a saw blade connected with said driving device;
a link having a first end connected to said saw blade guard and a second end opposite to said first end; and
a dust collection member pivotally connected to said saw blade guard and slidably coupled to the second end of said link, said dust collection member having a channel within which said saw blade passes during a cutting operation to cut a workpiece such that said channel guides cut chips from said workpiece to the outside of the miter saw via the inside space of said saw blade guard and said dust flue.

10. The miter saw according to claim 9, wherein the extending direction of said channel is substantially the same as a tangent direction of said saw blade.

11. The miter saw according to claim 9, wherein said link comprises a first connection member and a second connection member, said first connection member having one end thereof pivotally connected to one end of said second connection member and an opposite end thereof connected to said saw blade guard, said second connection member having an opposite end thereof slidably coupled to said dust collection member.

12. The miter saw according to claim 11, further comprising a biasing member positioned between said first connection member and said second connection member.

13. The miter saw according to claim 11, wherein said second connection member comprising two sliding slots, said dust collection member comprises two protruding portions respectively slidably coupled to said sliding slots of said second connection member.

14. The miter saw according to claim 13, wherein said sliding slots of said second connection member are smoothly arched.

15. The miter saw according to claim 14, wherein said dust collection member comprises two sidewalls respectively pivotally connected to said saw blade guard, and an end wall connected between said sidewalls at a bottom side thereof and defining with said side walls said channel; said protruding portions respectively extending from said sidewalls.

16. The miter saw according to claim 15, wherein said dust collection member further comprises a baffle suspended in an entrance of said channel.
